(19) United States
(12) Patent Application Publication
(10) Pub. No.: US 2022/0406056 A1
(43) Pub. Date: Dec. 22, 2022

(54) REMOTE SENSING OF TERRAIN STRENGTH FOR MOBILITY MODELING

(71) Applicants: MICHIGAN TECHNOLOGICAL UNIVERSITY, Houghton, MI (US); U.S. Army DEVCOM Ground Vehicle Systems Center (GVSC), Warren, MI (US)

(72) Inventors: Jordan Ewing, Warren, PA (US); Thomas Oommen, Houghton, MI (US); Russell Alger, Calumet, MI (US); Paramsothy Jayakumar, Warren, MI (US)

(21) Appl. No.: 17/697,158

(22) Filed: Mar. 17, 2022

Related U.S. Application Data
(60) Provisional application No. 63/162,448, filed on Mar. 17, 2021.

(51) Int. Cl. G06V 20/10; G06V 10/766; G06V 10/14

(52) U.S. Cl. CPC G06V 20/194; G06V 10/766; G06V 10/14

(57) ABSTRACT

Methods for characterizing soil stiffness of an area. One example method includes receiving, with an electronic processor, a parameter corresponding to a soil type of the area; receiving, with the electronic processor, a plurality of thermal images of the area; determining, with the electronic processor, an apparent thermal inertia of the area based on the plurality of thermal images; determining, with the electronic processor, a soil gradation of the area based on the parameter; determining, with a machine learning algorithm executed by the electronic processor, an approximate soil stiffness of the area based on the apparent thermal inertia; and outputting, to a display communicatively coupled to the electronic processor, a representation of the approximate soil stiffness.

### CROSS-REFERENCE TO RELATED APPLICATIONS

The present application is related to and claims benefit under 35 U.S.C. § 119(e) from U.S. Provisional Patent Application Ser. No. 63/162,448, filed Mar. 17, 2021, entitled “REMOTE SENSING OF TERRAIN STRENGTH FOR MOBILITY MODELING,” the entire contents of which being incorporated herein by reference.

### STATEMENT OF GOVERNMENT INTEREST

This invention was made with government support under grant number W56HZV1420001 awarded by the Department of Defense. The government has certain rights in the invention.

### FIELD OF DISCLOSURE

Embodiments described herein relate to determining soil strength properties of an area for accurate generation of Go/No-Go mobility maps.

### SUMMARY

There is work currently being done to characterize terrain strength and land mapping for autonomous mobility and simulation modeling. The mobility of military vehicles in unknown territories is one such example. The terrain strength parameter is one of the critical inputs for developing the Go/No-Go mobility maps that are used for autonomous mobility. Past models for characterizing the terrain strength have relied primarily on in-situ measurements. Bevameters have been the traditional best choice for the in-situ approximation of soil strength. The bevameter is quite expensive and difficult to transport, so the cone penetrometer is an excellent second choice for collecting terrain strength. However, in-situ measurements are challenging to obtain in warzones. Therefore, developing alternate approaches for in-situ terrain strength characterization is a priority for autonomous mobility.

Another important input component for developing mobility maps is the soil type of the area being mapped. The standard for characterizing a soil type within engineering is the Unified Soil Classification System (USCS), which describes the gradation and texture of a soil. Having a standardized soil classification via the USCS is useful to help develop soil type mapping. One of the essential details that controls the physical and mechanical properties of the soil is the grain size distribution (gradation). The gradation of a soil carries key details about the soil's mechanical behavior. Studies have shown that one could create an index to correlate to these values. However, as noted, certain environmental conditions may make it difficult to obtain in-situ measurements for characterizing soil based on soil gradation and texture.

An alternative for in-situ soil characterization is the use of remote sensing technology. Remote sensing has evolved with more computational capabilities and improved sensors to be a more time-efficient and accurate tool that continues to grow. Remote sensing can allow for the efficient and rapid collection over an area of interest safely and cost-effectively. Previous work has been done studying the use of cameras, Unmanned Aerial Vehicles (UAVs), and satellites to estimate sand lower bound friction angles and bearing strength. Remote sensing has many different types, based on the wavelength used for sensing and spectral resolution such as hyperspectral, multispectral, thermal, etc.

Hyperspectral imaging is one branch of remote sensing that has been used for the improvement of target recognition, and background characterization. Hyperspectral imaging shows potential to provide new methods for soil mapping, and can be used to estimate different features for a bare soil. Thermal remote sensing provides a simple approach to gathering information about the subsurface properties of the soil. Archeologists have used this for identifying the location of buried structures and buried objects. It has also similarly been used to quantify moisture at soil sites and mine tailings, and relating Thermal Inertia (TI)/Apparent Thermal Inertia (ATI) to land use/land cover mapping. ATI has been used for studying mobility purposes as well, identifying the morphology and composition of Mars, and TI for examining heterogeneity of Mars.

As a non-destructive and efficient data collection method, remote sensing shows great promise for soil characterization purposes. Therefore, the use of hyperspectral remote sensing within the visible and near-infrared (NIR) range (400-1000 nm) is beneficial for developing mobility maps. Some embodiments described herein use hyperspectral imagery to provide a soil classification index, which in turn helps predict the gradation of the soil based on five distinct soil types. In addition, using thermal imaging, some embodiments described herein use ATI to predict the soil strength of each soil type in terms of soil stiffness and cone penetrometer measurements. Using embodiments described herein, ATI, being a function of the object property of the material, can be correlated to the strength of the soil. Therefore, embodiments described herein provide an effective means for, among other things, developing mobility maps.

In particular, embodiments described herein provide a method for characterizing soil stiffness of an area, the method comprising: receiving, with an electronic processor, a parameter corresponding to a soil type of the area; receiving, with the electronic processor, a plurality of thermal images of the area; determining, with the electronic processor, an apparent thermal inertia of the area based on the plurality of thermal images; determining, with the electronic processor, a soil gradation of the area based on the parameter; determining, with a machine learning algorithm executed by the electronic processor, an approximate soil stiffness of the area based on the apparent thermal inertia; and outputting, to a display communicatively coupled to the electronic processor, a representation of the approximate soil stiffness.

Other embodiments described herein provide a non-transitory computer-readable medium comprising a set of instructions that, when executed by an electronic processor, cause the electronic processor to perform a set of operations for characterizing soil stiffness of an area, the set of operations comprising: receiving a parameter corresponding to a soil type of the area; receiving a plurality of thermal images of the area; determining, with the electronic processor, an apparent thermal inertia of the area based on the plurality of thermal images; determining, with the electronic processor, a soil gradation of the area based on the parameter; determining, with a machine learning algorithm executed by the electronic processor, an approximate soil stiffness of the area based on the apparent thermal inertia; and outputting, to a display communicatively coupled to the electronic processor, a representation of the approximate soil stiffness.

Other aspects of the disclosure will become apparent by consideration of the detailed description and accompanying drawings.

### BRIEF DESCRIPTION OF THE DRAWINGS

FIG. 1 is a block diagram of a system for characterizing soil stiffness of an area, according to some embodiments.

FIG. 2 is an example area containing different types of soil.

FIG. 3 is a table of soil classifications, according to some embodiments.

FIG. 4 is a graph showing a relationship between soil classification and percent gravel, according to some embodiments.

FIG. 5 is a graph showing a relationship between soil classification and percent sand, according to some embodiments.

FIG. 6 is a table of albedo values for different soil classifications, according to some embodiments.

FIG. 7 is a table of soil characteristics of different soil classifications, according to some embodiments.

FIG. 8 is a graph showing relationships between reflectance and wavelength of different soil classifications, according to some embodiments.

FIG. 9 is a graph showing relationships between temperature and time of different soil classifications, according to some embodiments.

FIG. 10 is a graph showing relationships between apparent thermal inertia (ATI) and time of different soil classifications, according to some embodiments.

FIG. 11 is a method of characterizing soil stiffness, according to some embodiments.

FIG. 12 is a method of determining approximate soil stiffness based on a linear regression technique, according to some embodiments.

FIG. 13 is a method of determining approximate soil stiffness based on a ridge regression technique, according to some embodiments.

FIG. 14 is a method of determining approximate soil stiffness based on a lasso regression technique, according to some embodiments.

FIG. 15 is a method of determining approximate soil stiffness based on a partial least squares regression technique, according to some embodiments.

FIG. 16 is a method of determining approximate soil stiffness based on a K nearest neighbors regression technique, according to some embodiments.

FIG. 17 is a method of determining approximate soil stiffness based on a support vector machine (SVM) regression technique, according to some embodiments.

FIGS. 18A and 18B are example hyperspectral images of soil gradation of an area.

FIGS. 19A-E are example ATI prediction maps of an area.

### DETAILED DESCRIPTION

One or more embodiments and various aspects are described and illustrated in the following description and accompanying drawings. These embodiments, examples, and aspects are not limited to the specific details provided herein and may be modified or combined in various ways. Furthermore, other embodiments, examples, and aspects may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used herein, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Also, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

Remote sensing, as the term is used herein, is the process of quantifying the physical characteristics of an object by measuring the reflected and emitted components of the Electro-Magnetic (EM) spectrum. The variations in the characteristics of an object such as roughness, texture, colors, etc. influence the reflectance or emittance of the EM spectrum. This influence leads to unique spectral characteristics for different objects. Different cameras can detect the different wavelengths of the EM spectrum. Some cameras can sense several narrow EM wavelengths, whereas some other cameras can detect fewer broader EM wavelengths. Depending on the number of wavelengths and the width of the wavelength that the camera can sense, it can be differentiated as a multispectral or hyperspectral camera. A multispectral camera typically detects few bands (e.g., 3 to 10 bands), with each band being a broader wavelength. On the other hand, the hyperspectral camera detects a large number of bands (e.g., hundreds or thousands of bands), with each band being a narrower wavelength. Remote sensing cameras are also classified based on the wavelength range that it measures.

Similarly, thermal imagery measures the emitted radiance of the material, quantifying the material's bulk properties. The thermal remote sensing provides a unique opportunity to understand the bulk properties of the object based on its emittance. In contrast, most other spectral wavelength measurements capture the reflected property from the surface of the object.

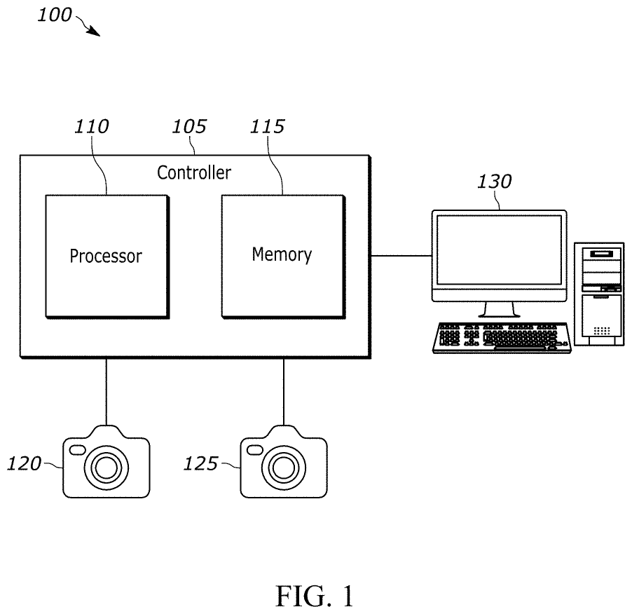

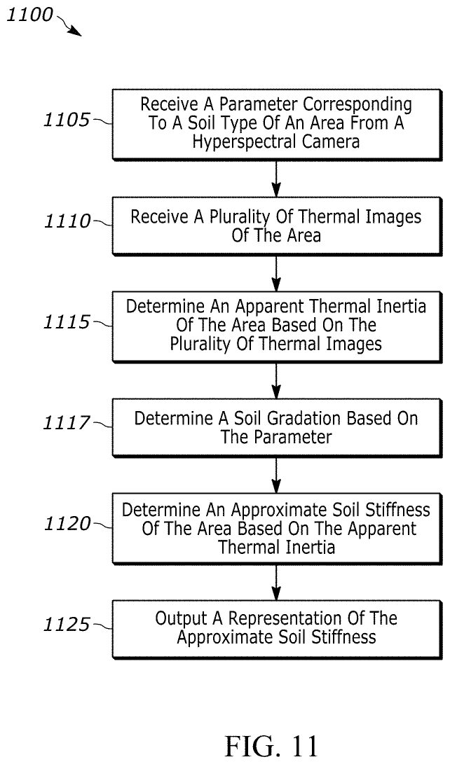

FIG. 1 is a block diagram of a system 100 for characterizing soil stiffness of an area. The system 100 includes a controller 105 including an electronic processor 110 and a memory 115. In some embodiments, the memory 115 stores one or more sets of instructions that, when executed by the electronic processor 110, cause the electronic processor 110 to perform a set of operations. Some such operations are described with respect to FIGS. 11-17. The system 100 also includes a first sensor 120 connected to the controller 105. In some embodiments, the first sensor 120 is a hyperspectral sensor (e.g., a hyperspectral camera) that is sensitive to the visible and near-infrared spectrum (400-1000 nm) and captures 120 bands with spectral accuracy of 5-7 nm full width at half maximum (FWHM). The system 100 also includes a second sensor 125 connected to the controller 105. In some embodiments, the second sensor 125 is thermal imaging device (e.g., a thermal camera) (7.5-13.5 μm) which quantifies the temperature of an object. In some embodiments, the first sensor 120 and the second sensor 125 are in direct electrical communication with the controller 105. In other embodiments, the first sensor 120 and the second sensor 125 send signals to the controller 105 over a communication network, such as a Bluetooth, Wi-Fi, cellular, or satellite network. The system 100 also includes a display 130 connected to the controller 105. The display 130 may be a separate computer system for receiving and displaying information generated by the controller 105. In some embodiments, the display 130 is directly connected to the controller 105. In other embodiments, the display 130 is connected to the controller 105 over a communication network, such as a Bluetooth, Wi-Fi, cellular, or satellite network.

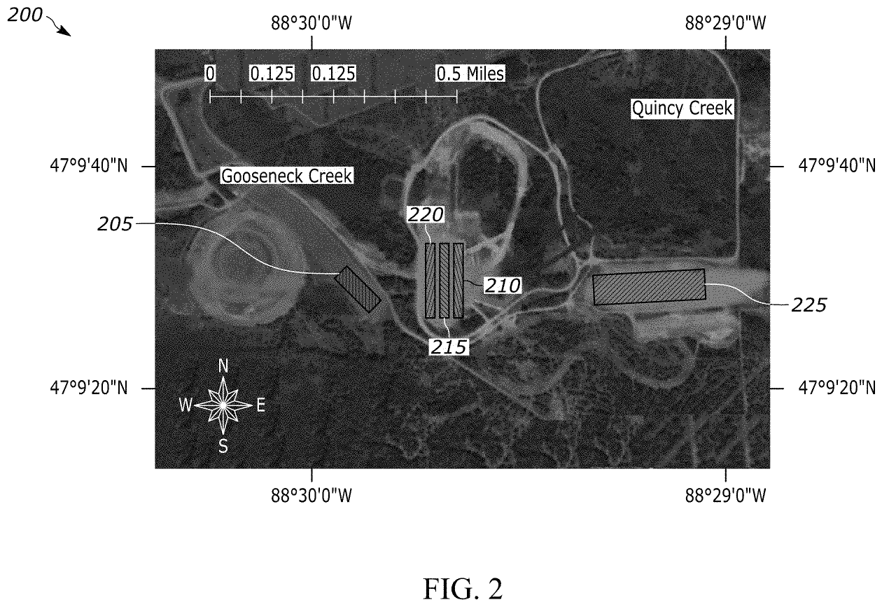

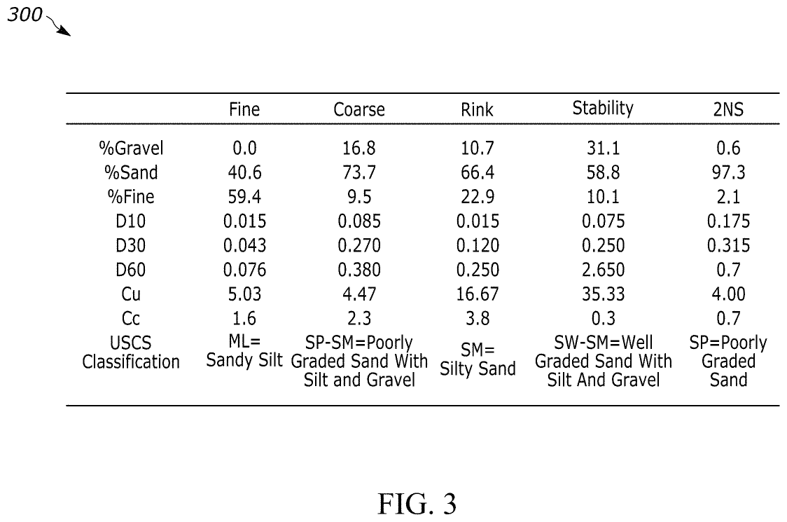

The system 100 may be used to identify different soil types within an area. FIG. 2 is an example area 200 containing different types of soil that the system 100 may be able to identify. The example area 200 includes different regions, each having a different soil classification. In particular, the example area 200 includes a first region 205 having fine soil, a second region 210 having 2NS soil, a third region 215 having rink soil, a fourth region 220 having coarse soil, and a fifth region 225 having stability soil. The five general types of soil present in the example area 200 (i.e., fine, coarse, rink, stability, and 2NS) are described further with respect to FIGS. 3-10.

The five general types of soil can be identified based on components of the soil. FIG. 3 is a table 300 of soil classifications. Fine soil (USCS Classification ML) is sandy silt and has a sand content of roughly 40.6% and a fine silt content of roughly 59.4%. Coarse soil (USCS Classification SP-SM) is poorly graded sand with silt and gravel, and has a gravel content of roughly 16.8%, a sand content of roughly 73.7%, and a fine silt content of roughly 9.5%. Rink soil (USCS Classification SM) is silty sand, and has a gravel content of roughly 10.7%, a sand content of roughly 66.4%, and a fine silt content of roughly 22.9%. Stability soil (USCS Classification SW-SM) is well graded sand with silt and gravel, and has a gravel content of roughly 31.1%, a sand content of roughly 58.8%, and a fine silt content of roughly 10.1%. 2NS soil (USCS Classification SP) is poorly graded sand, and has a gravel content of roughly 0.6%, a sand content of roughly 97.3%, and a fine silt content of roughly 2.1%. The other parameters shown in the table 300 include the soil gradation: D10, D30, and D60 (the grain size at which 10%, 30%, and 60% of the sample pass through a specific sieve size), the coefficient of uniformity (Cu) and coefficient of curvature (Cc) given in equations (1) and (2):

$$C u = \frac{D 60}{D 10} \qquad ( 1 )$$

$$Cc = \frac{D 3 {0}^{2}}{D 10 \times D 60} \qquad ( 2 )$$

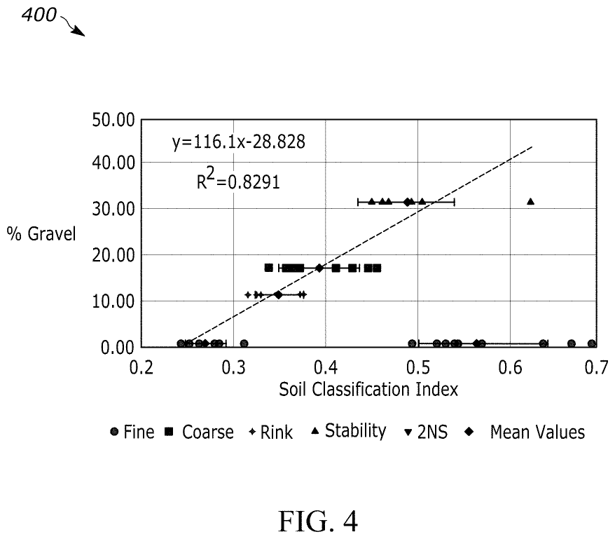

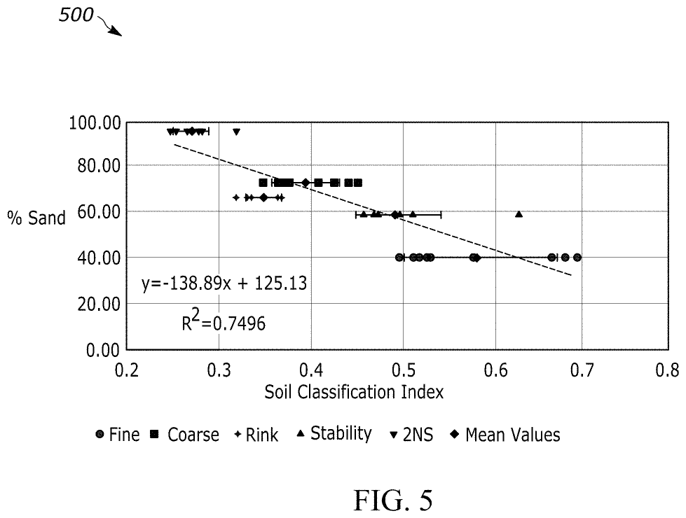

Furthermore, the gravel, sand, and fine silt contents of the five general types of soil may differ between samples taken. FIG. 4 is a graph 400 showing a relationship between soil classification and percent gravel, and FIG. 5 is a graph 500 showing a relationship between soil classification and percent sand.

A hyperspectral camera, such as the first sensor 120, may be used to determine the soil classification of a sample. In particular, soil classification may be determined based on an albedo of the sample. Albedo is a measure of diffuse reflection of solar radiation out of the total solar radiation applied to a sample. Albedo values are measured on a scale from 0 (i.e., a black body that absorbs all incident radiation) to 1 (i.e., a body that reflects all incident radiation). FIG. 6 is a table 600 of albedo values for the five general soil classifications. Using the hyperspectral camera may generate an albedo value of a measured region and return the value to the system 100. For example, a hyperspectral image of the first region 205 of the example area 200 (i.e., a fine soil region) may identify an albedo value of approximately 0.29320, indicating that the first region 205 is fine soil. Using this classification, the system 100 may be able to determine gravel, sand, and fine silt contents of the first region 205 based on average gravel, sand, and fine silt contents of the identified classification (for example, based on the graphs 400 and 500 of FIGS. 4 and 5).

Soil classification may also be determined based on thermal inertia (TI) and apparent thermal inertia (ATI). TI is a measurement of the potential of a material to absorb and store heat. TI may be calculated based on equation (3), with known thermal conductivity (k), bulk density (φ, and specific heat (c):

TI=\sqrt{k×ρ×c} (3)

However, thermal conductivity (k), bulk density (φ, and specific heat (c) cannot be collected using remote sensing. Therefore, TI can be approximated by ATI. ATI may be calculated based on variables that can be collected using remote sensing, namely change in temperature (ΔT) and albedo (α), with equation (4):

$$ATI = \frac{( 1 - α )}{Δ T} \qquad ( 4 )$$

As noted previously, the albedo (α) may be measured by a hyperspectral camera, such as the first sensor 120. The change in temperature (ΔT) may be measured by a thermal camera, such as the second sensor 125. Therefore, the system 100 has means to measure both albedo (α) and change in temperature (ΔT), and, thus, ATI.

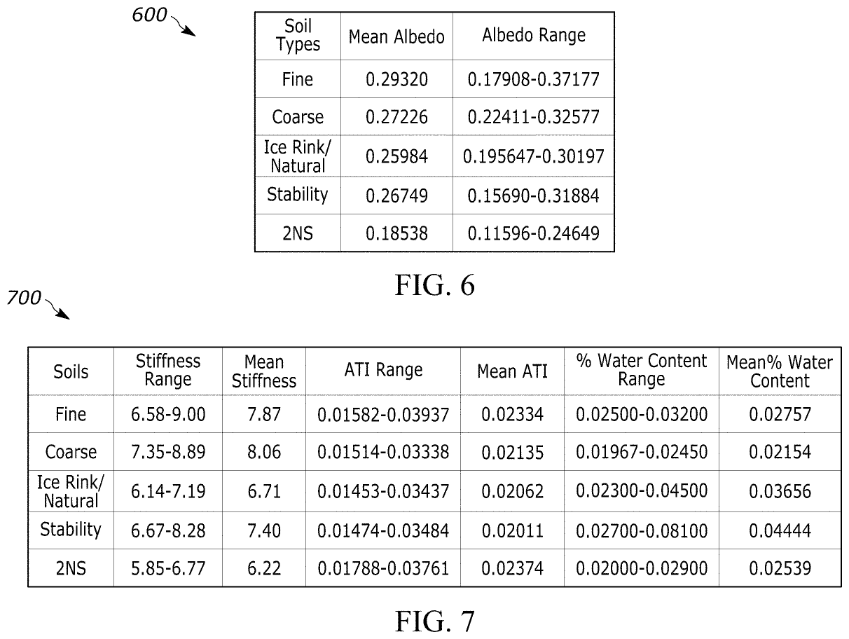

With ATI know, the system 100 may be able to determine soil classification. FIG. 7 is a table 700 of soil characteristics of different soil classifications. The table 700 shows mean ATI and ATI ranges for each of the five general soil classifications. The system 100 may be able to identify ATI and, based on the table 700, determine soil classification. With a known classification, the system 100 may be able to determine soil stiffness and generate a mobility map based on the soil stiffness of a region.

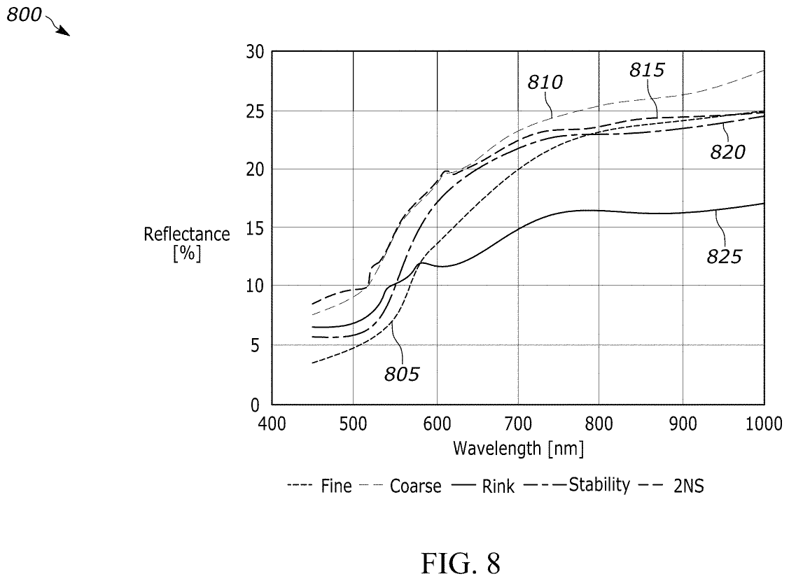

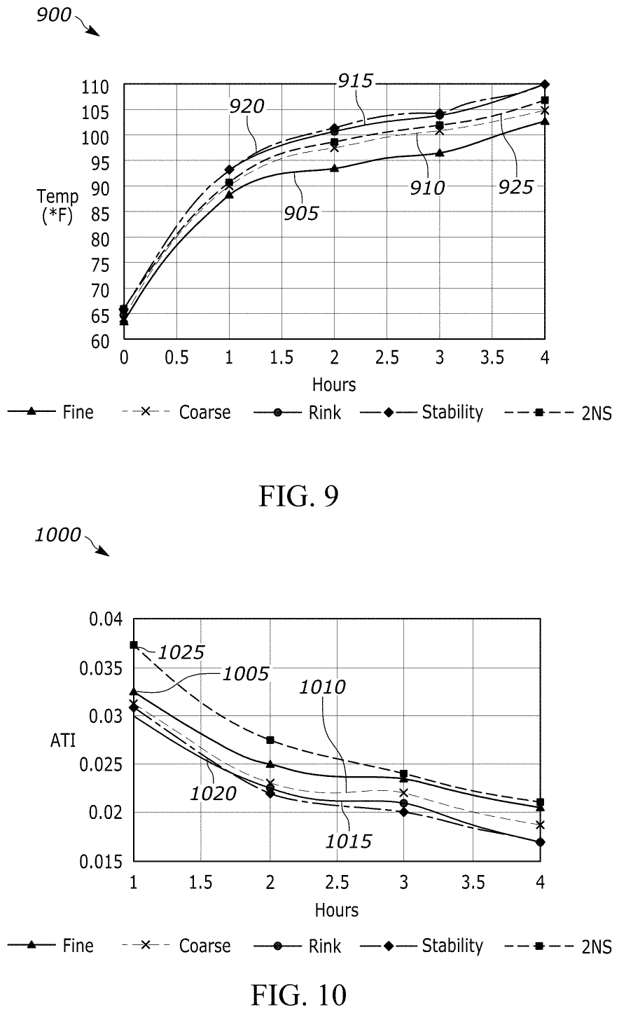

Different parameters of the soil classifications are shown by FIGS. 8-10. In particular, FIG. 8 is a graph 800 showing relationships between reflectance and wavelength of different soil classifications. The graph 800 includes a first line 805 representing fine soil, a second line 810 representing coarse soil, a third line 815 representing rink soil, a fourth line 820 representing stability soil, and a fifth 825 line representing 2NS soil. FIG. 9 is a graph 900 showing relationships between temperature and time of different soil classifications. The graph 900 includes a first line 905 representing fine soil, a second line 910 representing coarse soil, a third line 915 representing rink soil, a fourth line 920 representing stability soil, and a fifth line 925 representing 2NS soil. FIG. 10 is a graph 1000 showing relationships between apparent thermal inertia (ATI) and time of different soil classifications. The graph 1000 includes a first line 1005 representing fine soil, a second line 1010 representing coarse soil, a third line 1015 representing rink soil, a fourth line 1020 representing stability soil, and a fifth line 1025 representing 2NS soil.

Furthermore, as described herein, machine learning techniques may be implemented to enhance accuracy of the system 100. In particular, machine learning algorithms can mathematically predict the soil stiffness by using different inputs (such as water content, ATI, etc.). Various algorithms have different methodologies for how to predict this outcome. Some of algorithms are not scale-invariant, so Box-Cox transformation, centering, and scaling may be performed as an overall initial data preprocessing method.

Machine learning generally refers to the ability of a computer program to learn without being explicitly programmed. In some embodiments, a computer program (sometimes referred to as a learning engine) is configured to construct a model (for example, one or more algorithms) based on example inputs. Supervised learning involves presenting a computer program with example inputs and their desired (actual) outputs. The computer program is configured to learn a general rule (a model) that maps the inputs to the outputs in the training data. Machine learning may be performed using various types of methods and mechanisms, some of which are specified herein with respect to example embodiments. Example methods and mechanisms include decision tree learning, association rule learning, artificial neural networks, inductive logic programming, support vector machines, clustering, Bayesian networks, reinforcement learning, representation learning, similarity and metric learning, sparse dictionary learning, and genetic algorithms. Using some or all of these approaches, a computer program may ingest, parse, and understand data and progressively refine models for data analytics, including image analytics. Once trained, the computer system may be referred to as an intelligent system, an artificial intelligence (AI) system, a cognitive system, or the like.

As discussed previously, the system 100 includes a controller 105 having an electronic processor 110 and a memory 115 that stores one or more sets of instructions that, when executed by the electronic processor 110, cause the electronic processor 110 to perform a method. FIG. 11 is a method 1100 of characterizing soil stiffness. The method 1100 includes receiving a parameter corresponding to a soil type of the area (BLOCK 1105). In some embodiments, the parameter is an albedo value. The parameter may be received from a hyperspectral camera, such as the first sensor 120.

The method 1100 also includes receiving a plurality of thermal images of the area (BLOCK 1110). The plurality of thermal images may be received from a thermal camera, such as the second sensor 125. The plurality of thermal images may each show the same region at different times within an imaging period. The method 1100 also includes determining, with the electronic processor, an apparent thermal inertia of the area based on the plurality of thermal images (BLOCK 1115). The method 1100 also includes determining, with the electronic processor, a soil gradation based on the soil parameter (BLOCK 1117). In some embodiments, the soil gradation is a soil classification, such as fine soil, coarse soil, rink soil, stability soil, or 2NS soil. In some embodiments, the soil gradation is expressed in terms of or is a measure of what percentage of the soil is made up of gravel, what percentage of the soil is made up of sand, and what percentage of the soil is made up of fine content.

The method 1100 also includes determining, with a machine learning algorithm, an approximate soil stiffness of the area based on the apparent thermal inertia and the soil gradation (BLOCK 1120). In some embodiments, the machine learning algorithm is at least one from a group consisting of linear regression, ridge regression, lasso regression, partial least squares regression, K nearest neighbors regression, and SVM regression. The method 1100 also includes outputting to a display a representation of the approximate soil stiffness (BLOCK 1125). In some embodiments, the display is the display 130 of the system 100.

One possible machine learning algorithm is linear regression. Linear regression is the process of using a linear relationship between the predictors and the outcome while minimizing the sum of square error (SSE). Equation (5) shows the formula for SSE where n is the number of samples, yᵢ is the observed value of the response variable, and ŷᵢ is the predicted value for the response variable. This regression method is tuned by using different weight values as the coefficients for each of the predictors to help enhance the prediction capability, such as soil stiffness. This is a very quick computational model that is highly interpretable, but only performs well on data that has a linear relationship. As linear regression creates coefficients that are unbiased providing the lowest variance model, one can add bias to the coefficients allowing for penalized models such as ridge and lasso regression.

$$S S E = {\sum }_{i = 1}^{n} {( {y}_{i} - {\hat{y}}_{i} )}^{2} \qquad ( 5 )$$

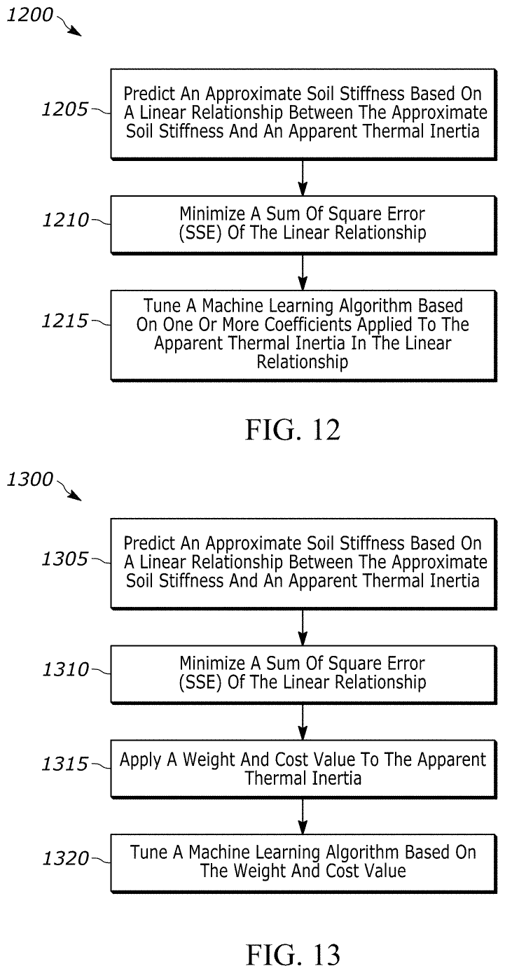

FIG. 12 is a method 1200 of determining approximate soil stiffness based on a linear regression technique. The method 1200 includes predicting the approximate soil stiffness based on a linear relationship between the approximate soil stiffness and the apparent thermal inertia (BLOCK 1205). The method 1200 also includes minimizing a sum of square error (SSE) of the linear relationship (BLOCK 1210). The method 1200 also includes tuning the machine learning algorithm based on one or more coefficients applied to the apparent thermal inertia in the linear relationship (BLOCK 1215).

Another possible machine learning algorithm is ridge regression. Ridge regression works by examining all of the input parameters and determines weights for each of those predictors' importance by utilizing the L2 regularization method, aka the square of the coefficient weights. Equation (6) shows the ridge regression algorithm where λ is the cost parameter and βⱼ is the weight for each individual predictor. In other words, the value of those predictors which are less useful will be shrunk down to smaller values, but not zero. This algorithm still maintains all the of the original predictors and does not perform feature selection. Tuning is performed by varying the cost (k).

Ridge_{SSE}=SSE+λΣβⱼ² (6)

FIG. 13 is a method 1300 of determining approximate soil stiffness based on a ridge regression technique. The method 1300 includes predicting the approximate soil stiffness based on a linear relationship between the approximate soil stiffness and the apparent thermal inertia (BLOCK 1305). The method 1300 also includes minimizing a sum of square error (SSE) of the linear relationship (BLOCK 1310). The method 1300 also includes applying a weight and a cost value to the apparent thermal inertia (BLOCK 1315). The method 1300 also includes tuning the machine learning algorithm based on the weight and the cost value (BLOCK 1320).

Another possible machine learning algorithm is lasso regression. Lasso regression works in a very similar manner to ridge regression, but instead of working with the L2 regularization, it instead works with the L1 regularization, or rather absolute value of the weight of the coefficients. Similarly, in the equation (7) for lasso regression, k is the cost parameter and β is the weight for each individual predictor. This method may create a reduction in certain situations where certain parameters may be of no use in the prediction process by setting their weight value to zero. Like that of ridge regression, tuning is performed over k.

Lasso_{SSE}=SSE+λΣ|βⱼ| (6)

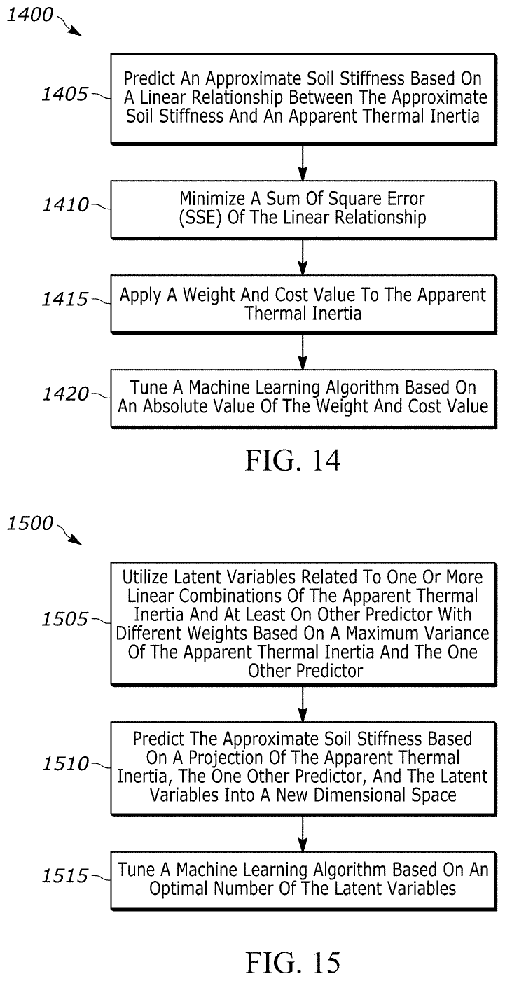

FIG. 14 is a method 1400 of determining approximate soil stiffness based on a lasso regression technique. The method 1400 includes predicting the approximate soil stiffness based on a linear relationship between the approximate soil stiffness and the apparent thermal inertia (BLOCK 1405). The method 1400 also includes minimizing a sum of square error (SSE) of the linear relationship (BLOCK 1410). The method 1400 also includes applying a weight and a cost value to the apparent thermal inertia (BLOCK 1415). The method 1400 also includes tuning the machine learning algorithm based on an absolute value of the weight and the cost value (BLOCK 1420).

Another possible machine learning algorithm is partial least squares regression. Partial least squares regression works by utilizing latent variables and projecting the data into a new dimensional space. The latent variables are linear combinations of the predictors with different weights to explain the maximum variance of the data to better predict the response variable. This methodology is similar to that of principal component regression. Finding the optimal number of latent variables to use is the tuning parameter for this algorithm.

FIG. 15 is a method 1500 of determining approximate soil stiffness based on a partial least squares regression technique. The method 1500 includes utilizing latent variables related to one or more linear combinations of the apparent thermal inertia and at least one other predictor with different weights based on a maximum variance of the apparent thermal inertia and the one other predictor (BLOCK 1505). The method 1500 also includes predicting approximate soil stiffness based on a projection of the apparent thermal inertia, the one other predictor, and the latent variables into a new dimensional space (BLOCK 1510). The method 1500 also includes tuning the machine learning algorithm based on an optimal number of the latent variables (BLOCK 1515).

Another possible machine learning algorithm is K nearest neighbors regression. K nearest neighbors works by taking a new data point and examining the data points surrounding it. Specifically, the data points that have the smallest distance from it. The number of nearest neighbors used is the tuning parameter for this model. One of the simplest ways of doing this is by going over a range of values for k and seeing which has the best performance, as was the case for this work.

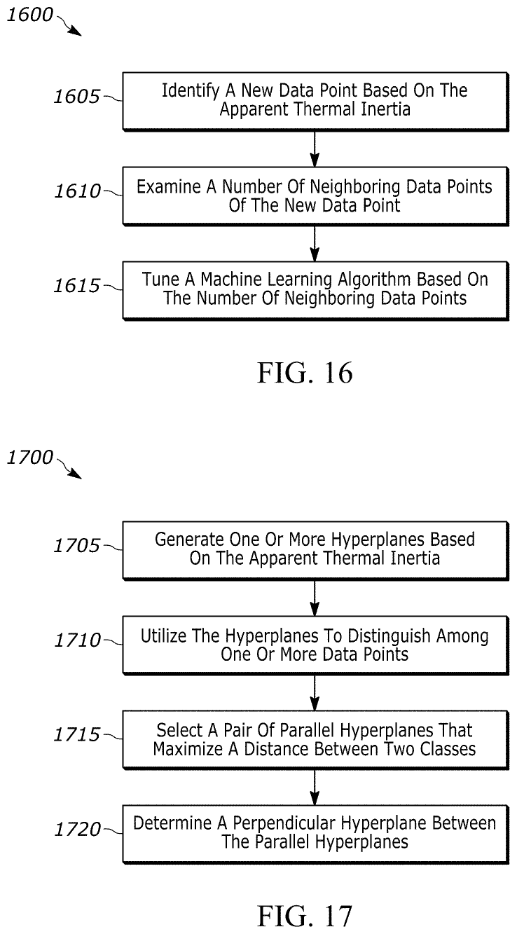

FIG. 16 is a method 1600 of determining approximate soil stiffness based on a K nearest neighbors regression technique. The method 1600 includes identifying a new data point based on the apparent thermal inertia (BLOCK 1605). The method 1600 also includes examining a number of neighboring data points of the new data point (BLOCK 1610). The method 1600 also includes tuning the machine learning algorithm based on the number of neighboring data points (BLOCK 1615).

Another possible machine learning algorithm is support vector machine (SVM) regression. SVMs work by utilizing a series of hyperplanes which act as a means of distinguishing among the data. In a two class linearly separable example parallel hyperplanes are generated from the samples and the pair of samples that maximize the distance between the two classes are selected, the support vectors. The middle of the support vectors is where a hyperplane is positioned perpendicular to both samples as a decision boundary between the two classes. The distance from this middle hyperplane to the nearest sample is called the margin. If the classes are not linearly separable then the kernel trick can be utilized, which maps the dataset into a linearly separable space. In some embodiments, a radial basis function kernel is used.

FIG. 17 is a method 1700 of determining approximate soil stiffness based on an SVM regression technique. The method 1700 includes generating one or more hyperplanes based on the apparent thermal inertia (BLOCK 1705). The method 1700 also includes utilizing the hyperplanes to distinguishing among one or more data points (BLOCK 1710). The method 1700 also includes selecting a pair of parallel hyperplanes that maximize a distance between two classes (BLOCK 1715). The method 1700 also includes determining a perpendicular hyperplane between the parallel hyperplanes (BLOCK 1720).

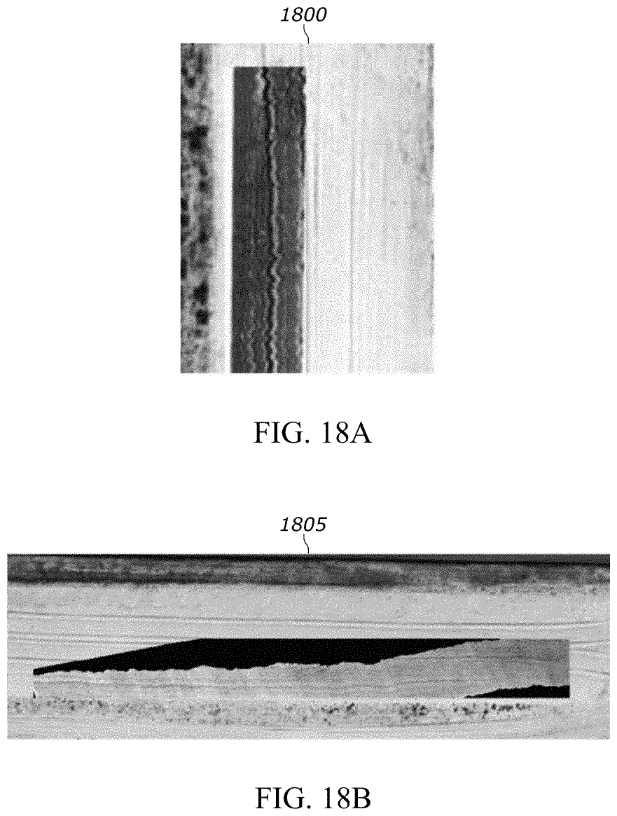

FIGS. 18A and 18B are example hyperspectral images 1800 and 1805 of soil gradation of an area. The example hyperspectral images 1800 and 1805 may be generated by the first sensor. The example hyperspectral images 1800 and 1805 may be output to the display 130.

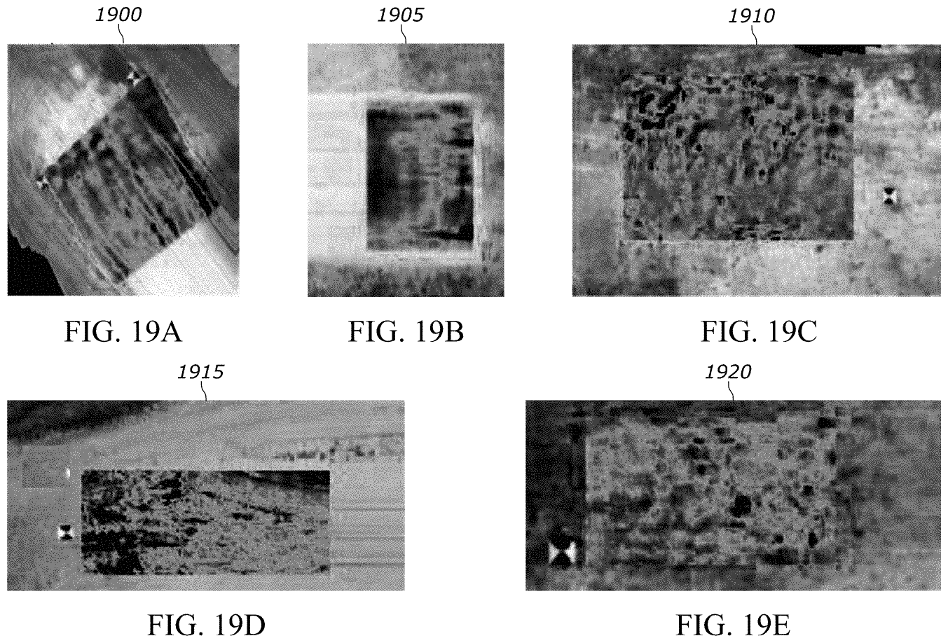

FIGS. 19A-E are example ATI prediction maps 1900, 1905, 1910, 1915, and 1920 of an area. The example ATI prediction maps 1900, 1905, 1910, 1915, and 1920 may be thermal images received from the second sensor 125 overlayed on digital elevation models (DEMs) of regions of the example area 200. For example, a first ATI prediction map 1900 corresponds to the first region 205 (fine soil), a second ATI prediction map 1905 corresponds to the second region 210 (2NS soil), a third ATI prediction map 1910 corresponds to the fifth region 225 (stability soil), a fourth ATI prediction map 1915 corresponds to the fourth region 220 (coarse soil), and a fifth ATI prediction map 1920 corresponds to the third region 215 (rink soil).

Various features and advantages of the embodiments and aspects described herein are set forth in the following claims.

What is claimed is:

1. A method for characterizing soil stiffness of an area, the method comprising:
receiving, with an electronic processor, a parameter corresponding to a soil type of the area from a hyperspectral sensor;
receiving, with the electronic processor, a plurality of thermal images of the area;
determining, with the electronic processor, an apparent thermal inertia of the area based on the plurality of thermal images;
determining, with the electronic processor, a soil gradation of the area based on the parameter;
determining, with a machine learning algorithm executed by the electronic processor, an approximate soil stiffness of the area based on the apparent thermal inertia and the soil gradation; and
outputting, to a display communicatively coupled to the electronic processor, a representation of the approximate soil stiffness.

2. The method of claim 1, wherein the parameter is an albedo value.

3. The method of claim 1, wherein each of the plurality of thermal images is a thermal image of the area taken by a thermal imaging device over an imaging period.

4. The method of claim 1, wherein the machine learning algorithm implements at least one from a group consisting of linear regression, ridge regression, lasso regression, partial least squares regression, K nearest neighbors regression, and SVM regression.

5. The method of claim 4, wherein the machine learning algorithm implements linear regression, and the method further includes:
predicting the approximate soil stiffness based on a linear relationship between the approximate soil stiffness and the apparent thermal inertia;
minimizing a sum of square error (SSE) of the linear relationship; and
tuning the machine learning algorithm based on one or more coefficients applied to the apparent thermal inertia in the linear relationship.

6. The method of claim 4, wherein the machine learning algorithm implements ridge regression, and the method further includes:
predicting the approximate soil stiffness based on a linear relationship between the approximate soil stiffness and the apparent thermal inertia;
minimizing a sum of square error (SSE) of the linear relationship;
applying a weight and a cost value to the apparent thermal inertia; and
tuning the machine learning algorithm based on the weight and the cost value.

7. The method of claim 4, wherein the machine learning algorithm implements lasso regression, and the method further includes:
predicting the approximate soil stiffness based on a linear relationship between the approximate soil stiffness and the apparent thermal inertia;
minimizing a sum of square error (SSE) of the linear relationship;
applying a weight and a cost value to the apparent thermal inertia; and
tuning the machine learning algorithm based on an absolute value of the weight and the cost value.

8. The method of claim 4, wherein the machine learning algorithm implements partial least squares regression, and the method further includes:
utilizing latent variables related to one or more linear combinations of the apparent thermal inertia and at least one other predictor with different weights based on a maximum variance of the apparent thermal inertia and the one other predictor;
predicting approximate soil stiffness based on a projection of the apparent thermal inertia, the one other predictor, and the latent variables into a new dimensional space; and
tuning the machine learning algorithm based on an optimal number of the latent variables.

9. The method of claim 4, wherein the machine learning algorithm implements K nearest neighbors regression, and the method further includes:
identifying a new data point based on the apparent thermal inertia;
examining a number of neighboring data points of the new data point; and
tuning the machine learning algorithm based on the number of neighboring data points.

10. The method of claim 4, wherein the machine learning algorithm implements SVM regression, and the method further includes:
generating one or more hyperplanes based on the apparent thermal inertia;
utilizing the hyperplanes to distinguishing among one or more data points;
selecting a pair of parallel hyperplanes that maximize a distance between two classes; and
determining a perpendicular hyperplane between the parallel hyperplanes.

11. A non-transitory computer-readable medium comprising a set of instructions that, when executed by an electronic processor, cause the electronic processor to perform a set of operations for characterizing soil stiffness of an area, the set of operations comprising:
receiving a parameter corresponding to a soil type of the area from a hyperspectral sensor;
receiving a plurality of thermal images of the area;
determining an apparent thermal inertia of the area based on the plurality of thermal images;
determining a soil gradation of the area based on the parameter;
determining, with a machine learning algorithm executed by the electronic processor, an approximate soil stiffness of the area based on the apparent thermal inertia and the soil gradation; and
outputting, to a display communicatively coupled to the electronic processor, a representation of the approximate soil stiffness.

12. The computer-readable medium of claim 11, wherein the parameter is an albedo value.

13. The computer-readable medium of claim 11, wherein each of the plurality of thermal images is a thermal image of the area taken by a thermal imaging device over an imaging period.

14. The computer-readable medium of claim 11, wherein the machine learning algorithm implements at least one from a group consisting of linear regression, ridge regression, lasso regression, partial least squares regression, K nearest neighbors regression, and SVM regression.

15. The computer-readable medium of claim 14, wherein the machine learning algorithm implements linear regression, and the set of operations further includes:
predicting the approximate soil stiffness based on a linear relationship between the approximate soil stiffness and the apparent thermal inertia;
minimizing a sum of square error (SSE) of the linear relationship; and
tuning the machine learning algorithm based on one or more coefficients applied to the apparent thermal inertia in the linear relationship.

16. The computer-readable medium of claim 14, wherein the machine learning algorithm implements ridge regression, and the set of operations further includes:
predicting the approximate soil stiffness based on a linear relationship between the approximate soil stiffness and the apparent thermal inertia;
minimizing a sum of square error (SSE) of the linear relationship;
applying a weight and a cost value to the apparent thermal inertia; and
tuning the machine learning algorithm based on the weight and the cost value.

17. The computer-readable medium of claim 14, wherein the machine learning algorithm implements lasso regression, and the set of operations further includes:
predicting the approximate soil stiffness based on a linear relationship between the approximate soil stiffness and the apparent thermal inertia;
minimizing a sum of square error (SSE) of the linear relationship;
applying a weight and a cost value to the apparent thermal inertia; and
tuning the machine learning algorithm based on an absolute value of the weight and the cost value.

18. The computer-readable medium of claim 14, wherein the machine learning algorithm implements partial least squares regression, and the set of operations further includes:
utilizing latent variables related to one or more linear combinations of the apparent thermal inertia and at least one other predictor with different weights based on a maximum variance of the apparent thermal inertia and the one other predictor;
predicting approximate soil stiffness based on a projection of the apparent thermal inertia, the one other predictor, and the latent variables into a new dimensional space; and
tuning the machine learning algorithm based on an optimal number of the latent variables.

19. The computer-readable medium of claim 14, wherein the machine learning algorithm implements K nearest neighbors regression, and the set of operations further includes:
identifying a new data point based on the apparent thermal inertia;
examining a number of neighboring data points of the new data point; and
tuning the machine learning algorithm based on the number of neighboring data points.

20. The computer-readable medium of claim 14, wherein the machine learning algorithm implements SVM regression, and the set of operations further includes:
generating one or more hyperplanes based on the apparent thermal inertia;
utilizing the hyperplanes to distinguishing among one or more data points;
selecting a pair of parallel hyperplanes that maximize a distance between two classes; and
determining a perpendicular hyperplane between the parallel hyperplanes.
